(19) United States
(12) Patent Application Publication
(10) Pub. No.: US 2025/0244522 A1
(43) Pub. Date: Jul. 31, 2025

(54) DISPLAY DEVICE

(71) Applicant: Japan Display Inc., Tokyo (JP)

(72) Inventors: Shinichi KOMURA, Tokyo (JP); Koichi OKUDA, Tokyo (JP); Jin HIROSAWA, Tokyo (JP)

(21) Appl. No.: 18/978,063

(22) Filed: Dec. 12, 2024

(30) Foreign Application Priority Data
Jan. 29, 2024 (JP) 2024-011140

(51) Int. Cl. F21V 8/00

(52) U.S. Cl. CPC G02B 6/0076; G02B 6/0068

(57) ABSTRACT

According to one embodiment, a display device includes a liquid crystal panel, an illumination device, and an optical sheet provided between the liquid crystal panel and the illumination device. The illumination device includes a plurality of light sources, a first light guide which has a first side surface facing the light sources, and a second side surface on a side opposite to the first side surface, a second light guide which faces the first light guide and has a third side surface, a transparent element which has a first plane being in contact with the second side surface and the third side surface, and a second plane located on a side opposite to the first plane and inclining with respect to the first plane, and a reflective element which faces the second plane.

### CROSS-REFERENCE TO RELATED APPLICATIONS

This application is based upon and claims the benefit of priority from Japanese Patent Application No. 2024-011140, filed Jan. 29, 2024, the entire contents of which are incorporated herein by reference.

### FIELD

Embodiments described herein relate generally to a display device.

### BACKGROUND

Recently, as display devices, various types of liquid crystal display devices have been put into practical use. For example, in liquid crystal display devices applied to a head-mounted display (HMD) worn on the head portion of the user, there are various requests such as the reduction in size and the improvement of the display quality.

### BRIEF DESCRIPTION OF THE DRAWINGS

FIG. 1 is a perspective view showing an example of the external appearance of a head-mounted display 1.

FIG. 2 is a diagram for explaining the configuration of the display devices DSP1 and DSP2 shown in FIG. 1.

FIG. 3 is a perspective view showing the configuration of a display panel PNL1.

FIG. 4 is a plan view showing a configuration example of an illumination device IL1.

FIG. 5 is a cross-sectional view showing a configuration example of the display device DSP1 including the illumination device IL1 shown in FIG. 4.

FIG. 6 is a cross-sectional view showing another configuration example of the display device DSP1 including the illumination device IL1 shown in FIG. 4.

FIG. 7 is a plan view showing another configuration example of the illumination device IL1.

FIG. 8 is a cross-sectional view showing a configuration example of the display device DSP1 including the illumination device IL1 shown in FIG. 7.

FIG. 9 is a cross-sectional view showing another configuration example of the display device DSP1 including the illumination device IL1 shown in FIG. 7.

FIG. 10 is a plan view showing another configuration example of the illumination device IL1.

FIG. 11 is a cross-sectional view showing another configuration example of the display device DSP1 including the illumination device IL1 shown in FIG. 10.

FIG. 12 is a plan view showing another configuration example of the illumination devices IL1 and IL2.

FIG. 13 is a plan view in which the cutout portion ILC of the illumination device IL1 shown in FIG. 12 is enlarged.

FIG. 14 is a diagram for explaining the optimization of the width of a transparent element TE in a first direction X.

### DETAILED DESCRIPTION

An object of the embodiments described herein is to provide a display device which enables the improvement of the display quality and the reduction in size.

In general, according to one embodiment, a display device comprises a liquid crystal panel, an illumination device which faces the liquid crystal panel, and an optical sheet provided between the liquid crystal panel and the illumination device. The illumination device comprises a plurality of light sources, a first light guide which has a first side surface facing the light sources, and a second side surface on a side opposite to the first side surface, a second light guide which faces the first light guide and has a third side surface, a transparent element which has a first plane being in contact with the second side surface and the third side surface, and a second plane located on a side opposite to the first plane and inclining with respect to the first plane, and a reflective element which faces the second plane.

According to another embodiment, a display device comprises a liquid crystal panel, an illumination device which faces the liquid crystal panel, and an optical sheet provided between the liquid crystal panel and the illumination device. The illumination device comprises a plurality of light sources, a first light guide which has a first side surface facing the light sources, and a second side surface on a side opposite to the first side surface, a second light guide which has a third side surface, a transparent element which has a first plane being in contact with the second side surface and the third side surface, a second plane located on a side opposite to the first plane and inclining with respect to the first plane, an upper surface located on a side facing the optical sheet between the first plane and the second plane, and a lower surface on a side opposite to the upper surface, and a reflective element which faces the second plane. The second light guide is provided between the first light guide and the optical sheet. In the transparent element, a width of the lower surface is less than a width of the upper surface.

According to yet another embodiment, a display device comprises a liquid crystal panel, an illumination device which faces the liquid crystal panel, and an optical sheet provided between the liquid crystal panel and the illumination device. The illumination device comprises a plurality of light sources, a first light guide which has a first side surface facing the light sources, and a second side surface on a side opposite to the first side surface, a second light guide which has a third side surface, a transparent element which has a first plane being in contact with the second side surface and the third side surface, a second plane located on a side opposite to the first plane and inclining with respect to the first plane, an upper surface located on a side facing the optical sheet between the first plane and the second plane, and a lower surface on a side opposite to the upper surface, and a reflective element which faces the second plane. The first light guide is provided between the second light guide and the optical sheet. In the transparent element, a width of the lower surface is greater than a width of the upper surface.

Embodiments will be described hereinafter with reference to the accompanying drawings.

The disclosure is merely an example, and the invention is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by like reference numbers and their detailed descriptions may be omitted unless necessary.

In the drawings, in order to facilitate understanding, an X-axis, a Y-axis and a Z-axis orthogonal to each other are shown depending on the need. A direction parallel to the X-axis is referred to as a first direction X. A direction parallel to the Y-axis is referred to as a second direction Y. A direction parallel to the Z-axis is referred to as a third direction Z. When various elements are viewed parallel to the third direction Z, the appearance is defined as a plan view. The first direction X and the second direction Y are directions parallel to each substrate included in the display panel or the main surface of each light guide included in the illumination device. The third direction Z corresponds to the thickness direction of the display device, the display panel and the illumination device.

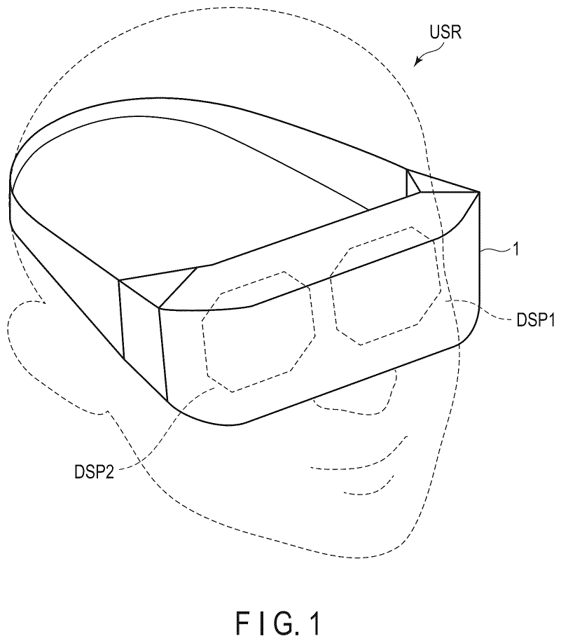

FIG. 1 is a perspective view showing an example of the external appearance of a head-mounted display 1.

The head-mounted display (HMD) 1 is, for example, worn on the head portion of the user USR to be used. The head-mounted display 1 is used to provide the user USR with, for example, virtual reality (VR) or augmented reality (AR).

The head-mounted display 1 comprises a display device DSP1 for the left eye and a display device DSP2 for the right eye. In a state where the user USR wears the head-mounted display 1 on the head portion, the display device DSP1 is provided to be located in front of the left eye of the user USR. In a state where the user USR wears the head-mounted display 1 on the head portion, the display device DSP2 is provided to be located in front of the right eye of the user USR. Details are described later.

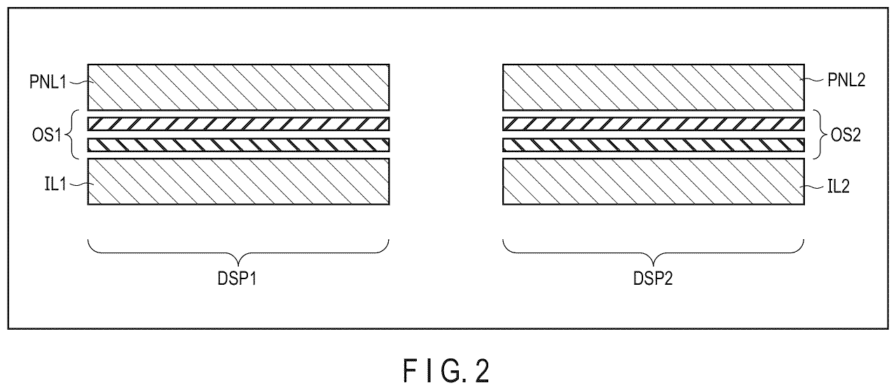

FIG. 2 is a diagram for explaining the configuration of the display devices DSP1 and DSP2 shown in FIG. 1.

The display device DSP1 comprises an illumination device IL1, optical sheets OS1 and a display panel PNL1. The illumination device IL1 is provided behind the display panel PNL1 and is configured to illuminate the display panel PN1. The optical sheets OS1 are provided between the illumination device IL1 and the display panel PNL1.

The display device DSP2 comprises an illumination device IL2, optical sheets OS2 and a display panel PNL2. The illumination device IL2 is provided behind the display panel PNL2 and is configured to illuminate the display panel PN2. The optical sheets OS2 are provided between the illumination device IL2 and the display panel PNL2.

Each of the optical sheets OS1 and the optical sheets OS2 is, for example, a prism sheet or diffusion sheet.

The display panel PNL1 and the display panel PNL2 are, for example, liquid crystal panels.

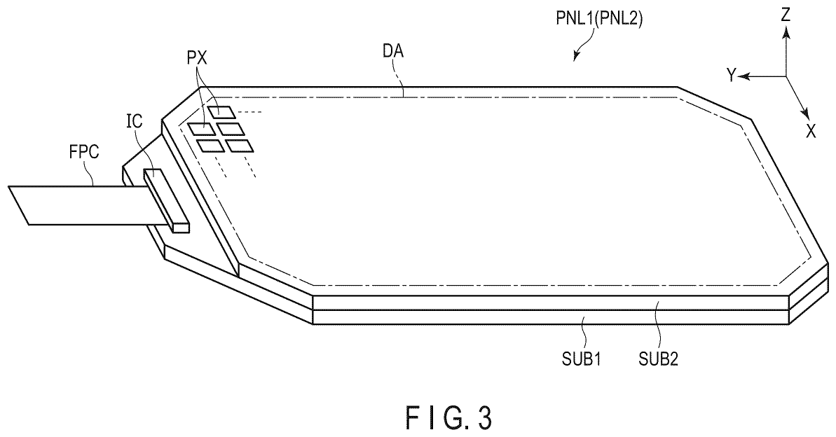

FIG. 3 is a perspective view showing the configuration of the display panel PNL1. The display panel PNL1 shown here is configured in the same manner as the display panel PNL2, explanation of the display panel PNL2 being omitted.

The display panel PNL1 comprises a first substrate SUB1 and a second substrate SUB2 facing the first substrate SUB1. The display panel PNL1 has a display area DA which displays an image. In the display area DA, a plurality of pixels PX are arrayed in matrix in a first direction X and a second direction Y.

A driver IC chip IC and a flexible printed circuit FPC for driving the display panel PNL1 are mounted on the first substrate SUB1.

In the example shown in FIG. 3, each of the first and second substrates SUB1 and SUB2 is octagonal as seen in plan view. The shape of each of the first and second substrates SUB1 and SUB2 is also regarded as a shape in which the four corners of a rectangle are cut. Since each of the first and second substrates SUB1 and SUB2 is octagonal, the display panel PNL1 is also octagonal in plan view. It should be noted that the shape of the display panel PNL1 is not limited to this example. The shape of the display panel PNL1 should be a shape at least to prevent the display panel PNL1 from hitting against the nose of the user USR (in other words, a shape having a cutout portion called a nose cut). For example, the shape of the display panel PNL1 may be an arbitrary polygon in which at least one corner close to the nose of the user USR is cut, or a circle.

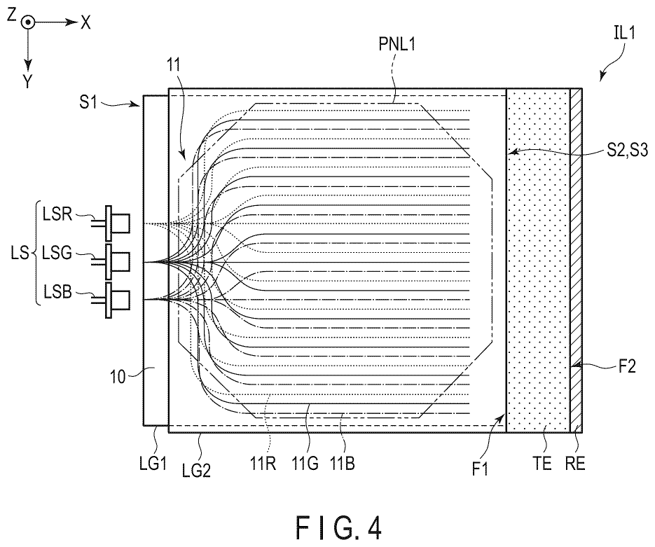

FIG. 4 is a plan view showing a configuration example of the illumination device IL1. The illumination device IL1 shown here is configured in the same manner as the illumination device IL2, explanation of the illumination device IL2 being omitted.

The illumination device IL1 comprises a plurality of light sources LS, a first light guide LG1, a second light guide LG2, a transparent element TE and a reflective element RE.

The light sources LS include a first light source LSR configured to emit a red laser beam, a second light source LSG configured to emit a green laser beam and a third light source LSB configured to emit a blue laser beam and are arranged in a second direction Y. In the example shown in the figure, one first light source LSR, one second light source LSG and one third light source LSB are provided. However, a plurality of first light sources LSR, a plurality of second light sources LSG and a plurality of third light sources LSB may be provided.

Each of the first light source LSR, the second light source LSG and the third light source LSB is, for example, a laser diode (semiconductor laser). The laser beam emitted from each light source has a high directivity (or linearity). However, it contains a diffusion component. For example, each of the red laser beam, blue laser beam and blue laser beam is linearly polarized light.

The first light guide LG1 is, for example, a glass substrate having a refractive index distribution for forming a plurality of optical waveguides. As seen in plan view, the first light guide LG1 has a first side surface S1, and a second side surface S2 on a side opposite to the first side surface S1. The first side surface S1 and the second side surface S2 face each other in a first direction X and extend in the second direction Y. In the example shown in the figure, the first side surface S1 and the second side surface S2 are parallel to a Y-Z plane defined by the second direction Y and a third direction Z.

The first side surface S1 faces the light sources LS in the first direction X and corresponds to the light incident surface of the first light guide LG1.

The first light guide LG1 comprises a base body (low refractive index portion) 10 having a first refractive index, and optical waveguides (high refractive index portion) 11 having a second refractive index which is higher than the first refractive index. Thus, in the first light guide LG1, the base body 10 corresponds to a cladding, and the optical waveguides 11 correspond to a core. The light which entered the optical waveguides 11 is totally reflected on the interface between the base body 10 and the optical waveguides 11.

Inside the first light guide LG1, the optical waveguides 11 extend from the first side surface S1 toward the second side surface S2 and are formed by branching on the way. The optical waveguides 11 are formed by, for example, applying laser beams to the base body 10 and changing the refractive index of part of the base body 10.

The optical waveguides 11 include an optical waveguide 11R (shown by dotted lines in FIG. 4) which has an end portion facing the first light source LSR, an optical waveguide 11G (shown by solid lines in FIG. 4) which has an end portion facing the second light source LSG, and an optical waveguide 11B (shown by one-dot chain lines in FIG. 4) which has an end portion facing the third light source LSB. For example, the optical waveguide 11R corresponds to a first optical waveguide. The optical waveguide 11G corresponds to a second optical waveguide. The optical waveguide 11B corresponds to a third optical waveguide. The optical waveguide 11R transmits red laser beams. The optical waveguide 11G transmits green laser beams. The optical waveguide 11B transmits blue laser beams.

For example, when the optical waveguide 11R is particularly looked at, the optical waveguide 11R has an end portion facing the first light source LSR on the first side surface S1, and has a plurality of end portions on the second side surface S2 side. On the second side surface S2 side, the end portions of the optical waveguide 11R, the end portions of the optical waveguide 11G and the end portions of the optical waveguide 11B are arranged in the second direction Y.

In the example shown in the figure, the end portions of the optical waveguides 11R, 11G and 11B face the first, second and third light sources LSR, LSG and LSB, respectively. However, optical fibers may be provided between the end portions of the optical waveguides 11R, 11G and 11B and the first, second and third light sources LSR, LSG and LSB such that they are optically coupled to each other.

The second light guide LG2 faces the first light guide LG1 in the third direction Z and is formed of, for example, a resinous material or a glass material. As seen in plan view, the second light guide LG2 has a third side surface S3. The third side surface S3 extends in the second direction Y and overlaps the second side surface S2 in the third direction Z. In the example shown in the figure, the third side surface S3 is parallel to a Y-Z plane.

The transparent element TE faces the first light guide LG1 and the second light guide LG2 in the first direction X and is formed of, for example, a resinous material. When each of red, green and blue laser beams is linearly polarized light, to maintain the polarization state, the transparent element TE should be preferably formed of a polymer in which the refractive anisotropy is nearly zero. Thus, the transparent element TE has an isotropic refractive index. In other words, in the transparent element TE, the orientation birefringence by stretching orientation is nearly zero, and further, the photoelastic birefringence by stress deformation is nearly zero. In the same light, the second light guide LG2 should be also preferably formed of a polymer in which the refractive anisotropy is nearly zero in a manner similar to that of the transparent element TE. Each of the transparent element TE and the second light guide LG2 can be formed of glass. However, in terms of the reduction in weight etc., each of them should be preferably formed of a polymer.

The transparent element TE has a first plane F1. The first plane F1 extends in the second direction Y and is parallel to a Y-Z plane. The first plane F1 is in contact with the second side surface S2 and the third side surface S3 and should preferably adhere to the second side surface S2 and the third side surface S3. The adhesive for causing the first plane F1 to adhere to the second side surface S2 and causing the first plane F1 to adhere to the third side surface S3 should be preferably a transparent material which has a refractive index equal to that of each of the transparent element TE, the first light guide LG1 and the second light guide LG2.

The transparent element TE has a second plane F2 on a side opposite to the first plane F1. The second plane F2 extends in the second direction Y. It should be noted that, as described later, the second plane F2 inclines with respect to the first plane F1 and is not parallel to a Y-Z plane.

The reflective element RE faces the second plane F2 in the first direction X. The reflective element RE is, for example, a reflective layer formed on the second plane F2. Here, the reflective layer may be a thin film which is directly formed on the second plane F2 or may be a reflective sheet which adheres to the second plane F2.

The display panel PNL1 shown by double chain lines faces the illumination device IL1 in the third direction Z.

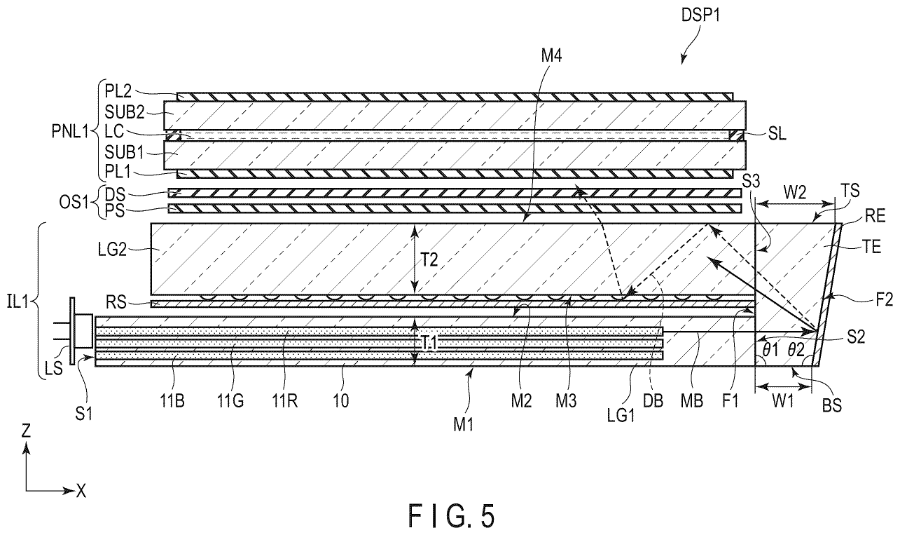

FIG. 5 is a cross-sectional view showing a configuration example of the display device DSP1 including the illumination device IL1 shown in FIG. 4. The display device DSP1 comprises the display panel PNL1 which is a liquid crystal panel, the illumination device IL1 and the optical sheets OS1.

In addition to the first and second substrates SUB1 and SUB2 described above, the display panel PNL1 comprises a sealing material SL, a liquid crystal layer LC, a first polarizer PL1 and a second polarizer PL2. The first substrate SUB1 and the second substrate SUB2 face each other in the third direction Z, and adhere to each other by the sealing material SL. The liquid crystal layer LC is held between the first substrate SUB1 and the second substrate SUB2, and is sealed by the sealing material SL. Although details are not explained, the first substrate SUB1 comprises signal lines, scanning lines, switching elements, pixel electrodes and the like. A common electrode which is common to a plurality of pixels may be provided in the first substrate SUB1 or may be provided in the second substrate SUB2.

The first polarizer PL1 is provided on the lower surface of the first substrate SUB1. The second polarizer PL2 is provided on the upper surface of the second substrate SUB2. The polarizing axes of the first and second polarizers PL1 and PL2 are, for example, orthogonal to each other.

In the illumination device IL1, the first light guide LG1 has a main surface M1, and a main surface M2 on a side opposite to the main surface M1. The main surface M1 and the main surface M2 face each other in the third direction Z and are parallel to each other. These main surfaces M1 and M2 are parallel to an X-Y plane defined by the first direction X and the second direction Y. In other words, the first light guide LG1 has a constant thickness T1 in the third direction Z from the first side surface S1 to the second side surface S2.

The optical waveguides 11R, 11G and 11B are formed hierarchically in different layers (heights) of the first light guide LG1 in the third direction Z without intersecting with each other. Further, the optical waveguides 11R, 11G and 11B do not bend in the third direction Z. The example of the figure shows a case where the optical waveguides 11R, 11G and 11B are arranged in this order from the upper side. However, the optical waveguides 11R, 11G and 11B may be arranged in an order different from FIG. 5 from the upper side. In the example of the figure, one optical waveguide 11R, one optical waveguide 11G and one optical waveguide 11B are shown. However, a plurality of optical waveguides 11R, a plurality of optical waveguides 11G and a plurality of optical waveguides 11B may be formed hierarchically.

The second light guide LG2 is provided between the first light guide LG1 and the optical sheets OS1 in the third direction Z. The second light guide LG2 has a main surface M3, and a main surface M4 on a side opposite to the main surface M3. The main surface M3 and the main surface M4 face each other in the third direction Z. The main surface M3 faces the main surface M2 in the third direction Z and has a plurality of tiny protrusions (prisms). The main surface M4 is parallel to an X-Y plane. The second light guide LG2 also has substantially a constant thickness T2 in the third direction Z. For example, thickness T2 is greater than thickness T1.

In the example shown in the figure, a reflective sheet RS is provided between the main surface M2 and the main surface M3 in the third direction Z.

The optical sheets OS1 are provided between the second light guide LG2 and the display panel PNL1 in the third direction Z. The optical sheets OS1 include, for example, a prism sheet PS and a diffusion sheet DS. The prism sheet PS has the function of causing the illumination light emitted from the illumination device IL1 to appropriately converge and refracting the illumination light. The diffusion sheet DS has the function of appropriately diffusing illumination light which passed through the prism sheet PS.

The transparent element TE has a trapezoidal section in an X-Z plane defined by the first direction X and the third direction Z. In addition to the first plane F1 and the second plane F2, the transparent element TE has an upper surface TS on a side facing the optical sheets OS1, and a lower surface BS on a side opposite to the upper surface TS. The upper surface TS and the lower surface BS face each other in the third direction Z and are parallel to each other. These upper and lower surfaces TS and BS are parallel to, for example, an X-Y plane. The first plane F1 and the second plane F2 face each other in the first direction X and are not parallel to each other. The first plane F1 is in contact with the second side surface S2 and the third side surface S3 as described above. The second plane F2 is covered with the reflective element RE.

Width W1 of the transparent element TE between the first light guide LG1 and the reflective element RE is less than width W2 of the transparent element TE between the second light guide LG2 and the reflective element RE (W1<W2). Here, the width of the transparent element TE is the length parallel to the first direction X from the first plane F1 to the second plane F2. The figure shows the width of the lower surface BS as an example of width W1 and shows the width of the upper surface TS as an example of width W2. In the transparent element TE, the width from the first plane F1 to the second plane F2 gradually increases from the lower surface BS to the upper surface TS.

From another viewpoint, in the transparent element TE, when the angle formed by the lower surface BS and the first plane F1 is defined as θ1, and the angle formed by the lower surface BS and the second plane F2 is defined as θ2, angle θ2 is greater than angle θ1 (θ1<θ2). For example, angle θ1 is a right angle, and angle θ2 is an obtuse angle.

In this display deice DSP1, the laser light emitted from each light source LS enters the first light guide LG1 and spreads in an X-Y plane while passing through one of the optical waveguides 11R, 11G and 11B. The red, green and blue laser beams are appropriately mixed when propagating through the base body 10 from the end portion of each optical waveguide to the second side surface S2. The principal ray MB which forms the luminance center of laser light and the diffused ray DB diffused from the principal ray MB pass through the first light guide LG1, enter the transparent element TE, are reflected on the reflective element RE, and subsequently enter the second light guide LG2. In the figure, the principal ray MB is shown by solid arrows, and the diffused ray DB is shown by dashed arrows.

The laser light which entered the second light guide LG2 proceeds while being totally reflected on the main surface M3 and the main surface M4. For example, the reflected light which is outside the conditions of total reflection in the prisms of the main surface M3 is emitted from the main surface M4 and forms illumination light.

The illumination light emitted from the illumination device IL1 passes through the prism sheet PS and the diffusion sheet DS, and at least part of the light passes through the first polarizer PL1. To prevent the absorption of illumination light in the first polarizer PL1, the laser light emitted from each light source LS should be preferably linearly polarized light parallel to the transmission axis of the first polarizer PL1. At least part of the illumination light which passed through the first polarizer PL1 is demodulated in the liquid crystal layer LC and is converted into display light. At least part of the display light passes through the second polarizer PL2 and forms a display image.

In the above description, this specification explains the display device DSP1 which consists of the illumination device IL1, the optical sheets OS1 and the display panel PNL1. It should be noted that, as the display device DSP2 is configured in the same manner as the display device DSP1, explanation of the display device DSP2 is omitted.

The display device explained above comprises the first light guide LG1 for transmitting the light emitted from the light sources LS while diffusing the light to the inside of the plane and mixing light beams having different colors, the second light guide LG2 which faces the first light guide LG1 in the thickness direction, and the transparent element TE and the reflective element RE for guiding the light transmitted by the first light guide LG1 to the second light guide LG2. By this configuration, in plan view, the entrance length for sufficiently mixing light beams having different colors can be shortened, and the size of the device can be reduced. Further, the non-uniformity in the luminance or color of illumination light can be prevented. Thus, the display quality can be improved.

In the configuration example shown in FIG. 4 and FIG. 5, the first light guide LG1 has the optical waveguides 11 formed by branching on the way. Thus, the light emitted from the light sources LS is appropriately distributed in the plane of the first light guide LG1. For this reason, even in a case where the number of light sources is less, the non-uniformity in the luminance or color of the illumination light can be prevented, and the cost can be reduced.

Now, another configuration example is explained. It should be noted that the same configurations as the above configuration example may be denoted by the same reference numbers, and explanation thereof may be omitted.

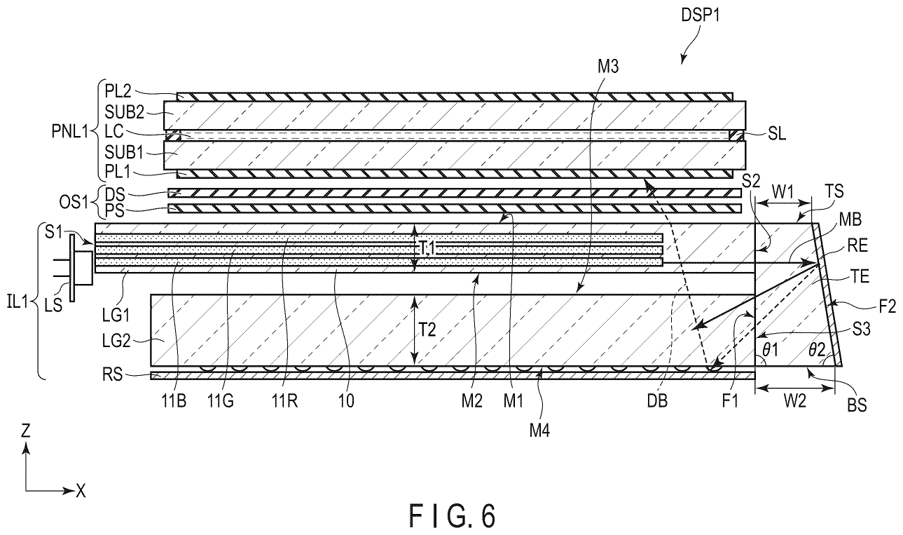

FIG. 6 is a cross-sectional view showing another configuration example of the display device DSP1 including the illumination device IL1 shown in FIG. 4.

The configuration example shown in FIG. 6 is different from that shown in FIG. 5 in respect that the illumination device IL1 is reversed up and down. The first light guide LG1 is provided between the second light guide LG2 and the optical sheets OS in the third direction Z.

The main surface M1 of the first light guide LG1 faces the optical sheets OS1. The main surface M2 faces the main surface M3 of the second light guide LG2. The main surface M4 faces the reflective sheet RS.

The transparent element TE has a trapezoidal section in an X-Z plane. The transparent element TE has the first plane F1, the second plane F2, the upper surface TS on a side facing the optical sheets OS1, and the lower surface BS on a side opposite to the upper surface TS. The upper surface TS and the lower surface BS face each other in the third direction Z and are parallel to each other. These upper and lower surfaces TS and BS are parallel to, for example, an X-Y plane. The first plane F1 and the second plane F2 face each other in the first direction X and are not parallel to each other. The first plane F1 is in contact with the second side surface S2 and the third side surface S3. The second plane F2 is covered with the reflective element RE.

Width W1 of the transparent element TE between the first light guide LG1 and the reflective element RE is less than width W2 of the transparent element TE between the second light guide LG2 and the reflective element RE (W1<W2). The figure shows the width of the upper surface TS as an example of width W1 and shows the width of the lower surface BS as an example of width W2. In the transparent element TE, the width from the first plane F1 to the second plane F2 gradually decreases from the lower surface BS to the upper surface TS.

From another viewpoint, in the transparent element TE, when the angle formed by the lower surface BS and the first plane F1 is defined as θ1, and the angle formed by the lower surface BS and the second plane F2 is defined as θ2, angle θ2 is less than angle θ1 (θ2<θ1). For example, angle θ1 is a right angle, and angle θ2 is an acute angle.

In this display device DSP1, the laser light emitted from each light source LS enters the first light guide LG1 and spreads in an X-Y plane while passing through one of the optical waveguides 11R, 11G and 11B. The red, green and blue laser beams are appropriately mixed when propagating through the base body 10 from the end portion of each optical waveguide to the second side surface S2. The principal ray MB and diffused ray DB of the laser light pass through the first light guide LG1, enter the transparent element TE, are reflected on the reflective element RE, and subsequently enter the second light guide LG2. In the figure, the principal ray MB is shown by solid arrows, and the diffused ray DB is shown by dashed arrows.

The laser light which entered the second light guide LG2 proceeds while being totally reflected on the main surface M3 and the main surface M4. For example, the reflected light which is outside the conditions of total reflection in the prisms of the main surface M4 is emitted from the main surface M3, passes through the first light guide LG1 and forms illumination light.

In this configuration example, effects similar to those of the configuration example explained above can be obtained. In addition, as shown in the dashed arrows in FIG. 6, the ray reflected on the prism after entering the second light guide LG2 is closer to the third side surface S3 compared with the configuration example shown in FIG. 5. In this manner, the display area of the display panel PNL1 can be expanded to a position close to the third side surface S3. In other words, the width of the frame of the display device DSP can be reduced.

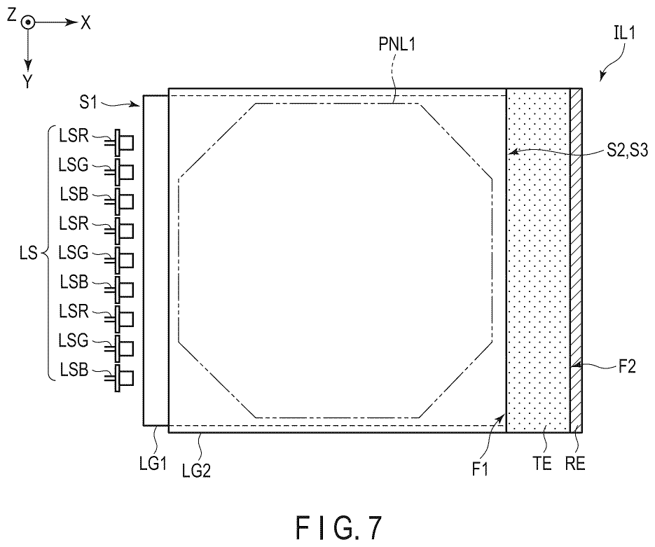

FIG. 7 is a plan view showing another configuration example of the illumination device IL1. The illumination device IL1 shown here is configured in the same manner as the illumination device IL2, explanation of the illumination device IL2 being omitted.

The illumination device IL1 comprises a plurality of light sources LS, the first light guide LG1, the second light guide LG2, the transparent element TE and the reflective element RE.

The configuration example shown in FIG. 7 is different from that shown in FIG. 4 in respect that more light sources LS are arranged in the second direction Y. Further, in the configuration example shown in the figure, the first light guide LG1 does not have a refractive index distribution for forming an optical waveguide.

The light sources LS include a plurality of first light sources LSR configured to emit red laser beams, a plurality of second light sources LSG configured to emit green laser beams and a plurality of third light sources LSB configured to emit blue laser beams and are arranged in the second direction Y.

The red laser beam emitted from each first light source LSR, the green laser beam emitted from each second light source LSG and the blue laser beam emitted from each third light source LSB are, for example, linearly polarized light.

Each of the first light guide LG1 and the second light guide LG2 is formed of, for example, a resinous material or a glass material. The transparent element TE is formed of, for example, a resinous material. When each of red, green and blue laser beams is linearly polarized light, to maintain the polarization state, each of the first light guide LG1, the second light guide LG2 and the transparent element TE should be preferably formed of a polymer in which the refractive anisotropy described above is nearly zero. In addition, in terms of the reduction in weight, each of the first light guide LG1, the second light guide LG2 and the transparent element TE should be preferably formed of a polymer.

The reflective element RE is, for example, a reflective layer formed on the second plane F2. Here, the reflective layer may be a thin film which is directly formed on the second plane F2 or may be a reflective sheet which adheres to the second plane F2.

The display panel PNL1 shown by double chain lines faces the illumination device IL1 in the third direction Z.

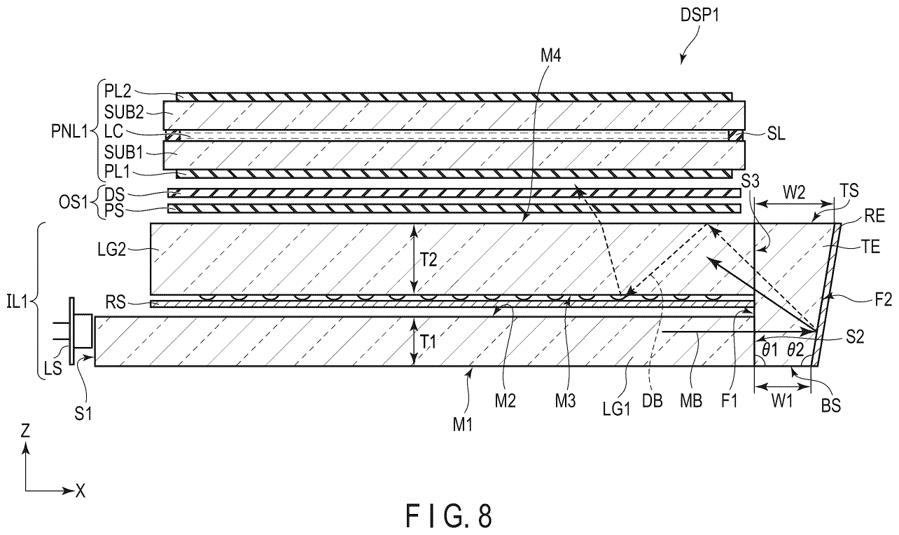

FIG. 8 is a cross-sectional view showing a configuration example of the display device DSP1 including the illumination device IL1 shown in FIG. 7.

The display panel PNL1 comprises the first substrate SUB1, the second substrate SUB2, the sealing material SL, the liquid crystal layer LC, the first polarizer PL1 and the second polarizer PL2.

The illumination device IL1 comprises the light sources LS, the first light guide LG1, the second light guide LG2, the transparent element TE and the reflective element RE. The second light guide LG2 is provided between the first light guide LG1 and the optical sheets OS1. The reflective sheet RS is provided between the first light guide LG1 and the second light guide LG2.

The transparent element TE has a trapezoidal section in an X-Z plane defined by the first direction X and the third direction Z. The transparent element TE has the first plane F1, the second plane F2, the upper surface TS on a side facing the optical sheets OS1, and the lower surface BS on a side opposite to the upper surface TS. The upper surface TS and the lower surface BS face each other in the third direction Z and are parallel to each other. These upper and lower surfaces TS and BS are parallel to, for example, an X-Y plane. The first plane F1 and the second plane F2 face each other in the first direction X and are not parallel to each other. The first plane F1 is in contact with the second side surface S2 and the third side surface S3. The second plane F2 is covered with the reflective element RE.

Width W1 of the transparent element TE between the first light guide LG1 and the reflective element RE is less than width W2 of the transparent element TE between the second light guide LG2 and the reflective element RE (W1<W2). The figure shows the width of the lower surface BS as an example of width W1 and shows the width of the upper surface TS as an example of width W2. The width of the transparent element TE gradually increases from the lower surface BS to the upper surface TS.

From another viewpoint, in the transparent element TE, angle θ1 formed by the lower surface BS and the first plane F1 is less than angle θ2 formed by the lower surface BS and the second plane F2 (θ1<θ2). For example, angle θ1 is a right angle, and angle θ2 is an obtuse angle.

In this configuration example, effects similar to those of the configuration example described above are obtained.

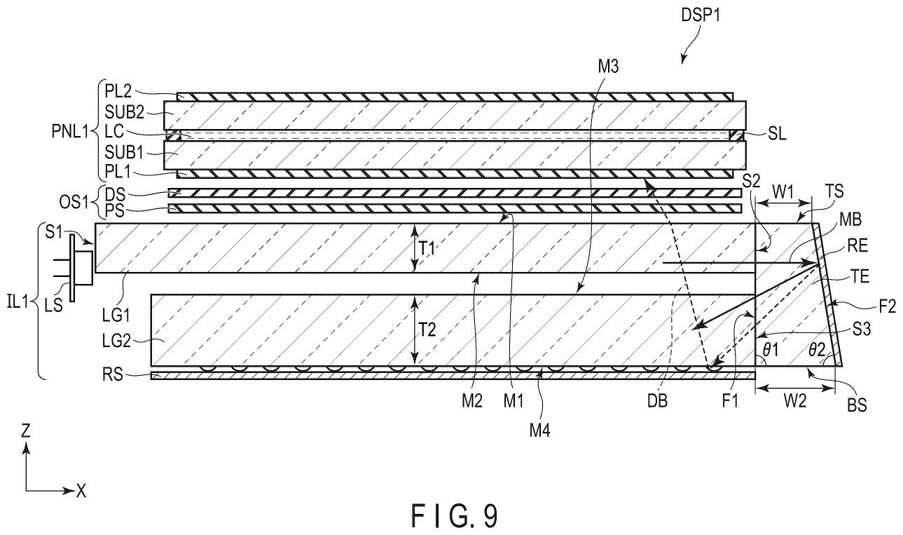

FIG. 9 is a cross-sectional view showing another configuration example of the display device DSP1 including the illumination device IL1 shown in FIG. 7.

The configuration example shown in FIG. 9 is different from that shown in FIG. 8 in respect that the illumination device IL is reversed up and down. The first light guide LG1 is provided between the second light guide LG2 and the optical sheets OS in the third direction Z.

The main surface M1 of the first light guide LG1 faces the optical sheets OS1. The main surface M2 faces the main surface M3 of the second light guide LG2. The main surface M4 faces the reflective sheet RS.

The transparent element TE has a trapezoidal section in an X-Z plane. Width W1 of the transparent element TE between the first light guide LG1 and the reflective element RE is less than width W2 of the transparent element TE between the second light guide LG2 and the reflective element RE (W1<W2). The figure shows the width of the upper surface TS as an example of width W1 and shows the width of the lower surface BS as an example of width W2. In the transparent element TE, the width from the first plane F1 to the second plane F2 gradually decreases from the lower surface BS to the upper surface TS.

From another viewpoint, in the transparent element TE, when the angle formed by the lower surface BS and the first plane F1 is defined as θ1, and the angle formed by the lower surface BS and the second plane F2 is defined as θ2, angle θ2 is less than angle θ1 (θ2<θ1). For example, angle θ1 is a right angle, and angle θ2 is an acute angle.

In this configuration example, effects similar to those of the configuration example described above are obtained.

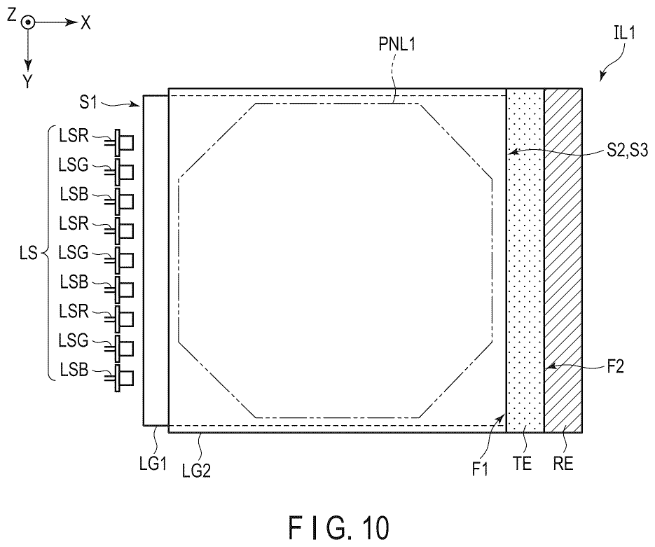

FIG. 10 is a plan view showing another configuration example of the illumination device IL1. The illumination device IL1 shown here is configured in the same manner as the illumination device IL2, explanation of the illumination device IL2 being omitted.

The illumination device IL1 comprises a plurality of light sources LS, the first light guide LG1, the second light guide LG2, the transparent element TE and the reflective element RE.

The configuration example shown in FIG. 10 is different from that shown in FIG. 7 in respect that the reflective element RE is a metallic body or a reflector in which a reflective layer is formed on the surface of a block. This reflective element RE is provided so as to face the transparent element TE in the first direction X. It should be noted that the reflective element RE may adhere to the transparent element TE or may face the transparent element TE via an air layer.

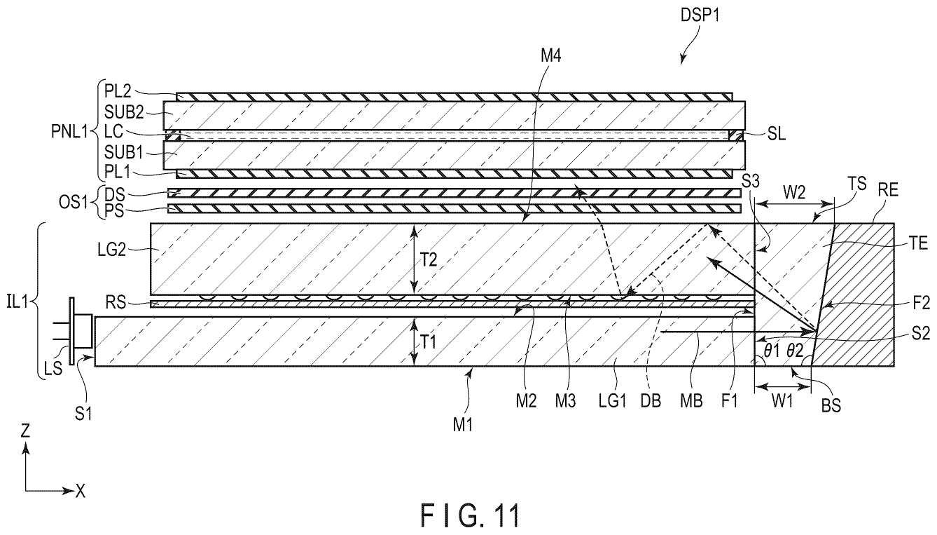

FIG. 11 is a cross-sectional view showing another configuration example of the display device DSP1 including the illumination device IL1 shown in FIG. 10.

In the configuration example shown in FIG. 11, the reflective element RE formed as a reflective layer (thin film) in the configuration example shown in FIG. 8 is replaced by a reflective element RE formed as a metallic body or a reflector. It should be noted that, similarly, the reflective element RE formed as a metallic body or a reflector can be applied the configuration examples shown in FIG. 5, FIG. 6 and FIG. 9.

Now, this specification explains the illumination devices IL1 and IL2 each having a cutout portion called a nose cut.

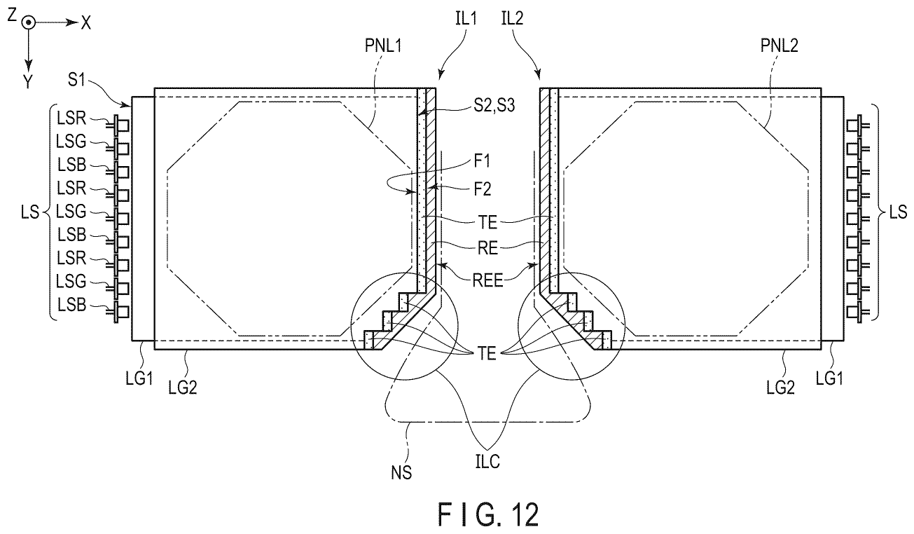

FIG. 12 is a plan view showing another configuration example of the illumination devices IL1 and IL2.

The illumination devices IL1 and IL2 are arranged in the first direction X and are provided so as to be symmetric with respect to the nose NS of the user shown by the one-dot chain line. Each of the illumination devices IL1 and IL2 has a cutout portion ILC for avoiding the contact with the nose NS. In the illumination devices IL1 and IL2, the configuration other than the cutout portions ILC is the same as the configuration example shown in FIG. 10 and FIG. 11. In the following description, the illumination device IL1 is explained, and explanation of the illumination device IL2 is omitted.

The outer edge REE of the reflective element RE is formed along the outer shape of the nose NS, linearly extends in the second direction Y and obliquely extends in the cutout portion ILC. The second side surface S2 and the third side surface S3 linearly extend in the second direction Y and are formed in a staircase pattern in the cutout portion ILC. The transparent elements TE are interposed between the reflective element RE and the second and third side surfaces S2 and S3. Hereinafter, the cutout portion ILC of the illumination device IL1 is more specifically explained.

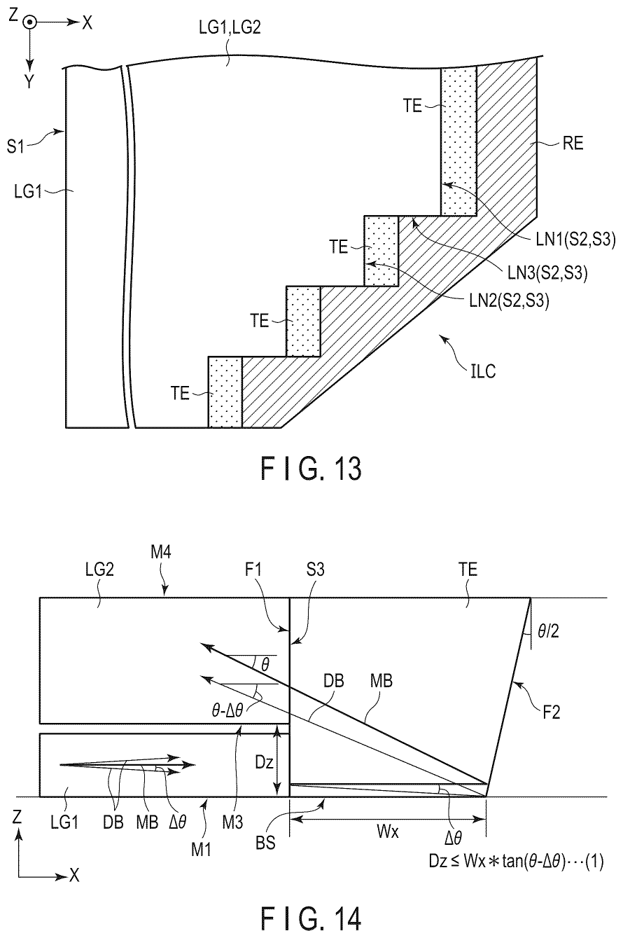

FIG. 13 is a plan view in which the cutout portion ILC of the illumination device IL1 shown in FIG. 12 is enlarged.

Each of the second and third side surfaces S2 and S3 includes at least a first linear portion LN1, a second linear portion LN2 which is closer to the first side surface S1 than the first linear portion LN1, and a third linear portion LN3 which connects the first linear portion LN1 and the second linear portion LN2 to each other. The first linear portion LN1 is longer than the second linear portion LN2. The first linear portion LN1 and the second linear portion LN2 are parallel to each other. In the example shown in the figure, both of the first linear portion LN1 and the second linear portion LN2 extend in the second direction Y. In the example shown in the figure, the third linear portion LN3 extends in the first direction X.

The transparent elements TE are provided between the first linear portion LN1 and the reflective element RE and between the second linear portion LN2 and the reflective element RE. Part of the third linear portion LN3 faces the reflective element RE without an intervention of the transparent elements TE in the second direction Y.

A set of each transparent element TE and the reflective element RE guides the leaser light emitted from the light sources LS from the first light guide LG1 to the second light guide LG2 in the first direction X as described above. If the transparent element TE is provided between the third linear portion LN3 and the reflective element RE, in an X-Y plane, the light which is emitted from the first light guide LG1 with a spread in an oblique direction with respect to the first direction X is guided to the second light guide LG2 in the second direction Y. Thus, non-uniformity in luminance may be caused in the cutout portion ILC. Therefore, when, as shown in the figure, the transparent element TE between the first linear portion LN1 and the reflective element RE is separated from the transparent element TE between the second linear portion LN2 and the reflective element RE, and no transparent element TE is provided between the third linear portion LN3 and the reflective element RE, the non-uniformity in luminance in the cutout portion ILC can be prevented.

It should be noted that, similarly, the cutout portion ILC described above can be applied to the configuration examples shown in FIG. 4 and FIG. 7.

FIG. 14 is a diagram for explaining the optimization of the width of the transparent element TE in the first direction X.

It is assumed that, in an X-Z plane, the principal ray MB is parallel to the first direction X, and the diffused ray DB inclines so as to form angle Δθ with the principal ray MB. Here, the conditions that all of the principal rays MB and the diffused rays DB are guided from the first light guide LG1 to the second light guide LG2 are considered.

When the principal ray MB forms angle θ with the first direction X in the second light guide LG2, the diffused ray DB forms angle (θ−Δθ) with the first direction X. At this time, in the transparent element TE, the second plane F2 inclines so as to form θ/2 with the first plane F1 parallel to the third direction Z. In order to cause the diffused ray DB to enter the upper side (the main surface M4 side) than the intersection of the main surface M3 and the third side surface S3 in the second light guide LG2 after the diffused ray DB is reflected near the intersection of the lower surface BS and the second plane F2 in the transparent element TE, the following relational expression is established.

Dz≤Wx*tan(θ−Δθ) (1)

Here, Dz is the interval between the main surface M1 of the first light guide LG1 and the main surface M3 of the second light guide LG2 in the third direction Z, and Wx is the minimum width in the first direction X in the transparent element TE (in the example of the figure, the width of the lower surface BS). Angle θ is set so as to be, for example, 26.5 degrees such that the light which was guided to the second light guide LG2 is emitted from the second light guide LG2 in the most efficient way.

By setting width Wx so as to satisfy this relationship, all of the principal rays MB and the diffused rays DB are guided from the first light guide LG1 to the second light guide LG2. Thus, the reduction in the light utilization efficiency is prevented.

The embodiments described above can provide a display device which enables the improvement of the display quality and the reduction in size.

While certain embodiments have been described, these embodiments have been presented by way of example only, and are not intended to limit the scope of the inventions. Indeed, these embodiments may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a liquid crystal panel;
an illumination device which faces the liquid crystal panel; and
an optical sheet provided between the liquid crystal panel and the illumination device, wherein
the illumination device comprises:
a plurality of light sources;
a first light guide which has a first side surface facing the plurality of light sources, and a second side surface on a side opposite to the first side surface;
a second light guide which faces the first light guide and has a third side surface;
a transparent element which has a first plane being in contact with the second side surface and the third side surface, and a second plane located on a side opposite to the first plane and inclining with respect to the first plane; and
a reflective element which faces the second plane.

2. The display device of claim 1, wherein
the first light guide is a glass substrate comprising:
a base body which has a first refractive index; and
a plurality of optical waveguides which extend from the first side surface toward the second side surface inside the base body, are formed by branching on a way, and have a second refractive index higher than the first refractive index, and
the first light guide has a constant thickness from the first side surface to the second side surface.

3. The display device of claim 2, wherein
the plurality of light sources include a first light source configured to emit a red laser beam, a second light source configured to emit a green laser beam and a third light source configured to emit a blue laser beam,
the plurality of optical waveguides include a first optical waveguide for transmitting the red laser beam, a second optical waveguide for transmitting the green laser beam and a third optical waveguide for transmitting the blue laser beam, and
the first optical waveguide, the second optical waveguide and the third optical waveguide are located hierarchically in a thickness direction of the first light guide without intersecting with each other and do not bend in the thickness direction.

4. The display device of claim 3, wherein
each of the red laser beam, the green laser beam and the blue laser beam is linearly polarized light, and
the transparent element is formed of a polymer in which refractive index anisotropy is nearly zero.

5. The display device of claim 4, wherein
the second light guide is formed of a polymer in which refractive index anisotropy is nearly zero.

6. The display device of claim 1, wherein
the plurality of light sources include a first light source configured to emit a red laser beam, a second light source configured to emit a green laser beam and a third light source configured to emit a blue laser beam,
each of the red laser beam, the green laser beam and the blue laser beam is linearly polarized light, and
the first light guide is formed of a polymer in which refractive index anisotropy is nearly zero.

7. The display device of claim 6, wherein
the transparent element is formed of a polymer in which refractive index anisotropy is nearly zero.

8. The display device of claim 7, wherein
the second light guide is formed of a polymer in which refractive anisotropy is nearly zero.

9. The display device of claim 1, wherein
the second light guide is provided between the first light guide and the optical sheet.

10. The display device of claim 1, wherein
the first light guide is provided between the second light guide and the liquid crystal panel.

11. The display device of claim 1, wherein
the reflective element is a reflective layer formed in the second plane.

12. The display device of claim 1, wherein
the reflective element is a metallic body or a reflector in which a reflective layer is formed on a surface of a block.

13. The display device of claim 1, wherein
in plan view, each of the second side surface and the third side surfaces includes a first linear portion, a second linear portion which is closer to the first side surface than the first linear portion, and a third linear portion which connects the first linear portion and the second linear portion to each other.

14. The display device of claim 13, wherein
the transparent element is provided between the first linear portion and the reflective element and between the second linear portion and the reflective element.

15. A display device comprising:
a liquid crystal panel;
an illumination device which faces the liquid crystal panel; and
an optical sheet provided between the liquid crystal panel and the illumination device, wherein
the illumination device comprises:
a plurality of light sources;
a first light guide which has a first side surface facing the plurality of light sources, and a second side surface on a side opposite to the first side surface;
a second light guide which has a third side surface;
a transparent element which has a first plane being in contact with the second side surface and the third side surface, a second plane located on a side opposite to the first plane and inclining with respect to the first plane, an upper surface located on a side facing the optical sheet between the first plane and the second plane, and a lower surface on a side opposite to the upper surface; and
a reflective element which faces the second plane,
the second light guide is provided between the first light guide and the optical sheet, and
in the transparent element, a width of the lower surface is less than a width of the upper surface.

16. The display device of claim 15, wherein
the first light guide is a glass substrate which has a refractive index distribution for forming a plurality of optical waveguides, and
each of the transparent element and the second light guide is formed of a polymer in which refractive index anisotropy is nearly zero.

17. The display device of claim 15, wherein
each of the first light guide, the transparent element and the second light guide is formed of a polymer in which refractive index anisotropy is nearly zero.

18. A display device comprising:
a liquid crystal panel;
an illumination device which faces the liquid crystal panel; and
an optical sheet provided between the liquid crystal panel and the illumination device, wherein
the illumination device comprises:
a plurality of light sources;
a first light guide which has a first side surface facing the plurality of light sources, and a second side surface on a side opposite to the first side surface;
a second light guide which has a third side surface;
a transparent element which has a first plane being in contact with the second side surface and the third side surface, a second plane located on a side opposite to the first plane and inclining with respect to the first plane, an upper surface located on a side facing the optical sheet between the first plane and the second plane, and a lower surface on a side opposite to the upper surface; and
a reflective element which faces the second plane,
the first light guide is provided between the second light guide and the liquid crystal panel, and
in the transparent element, a width of the lower surface is greater than a width of the upper surface.

19. The display device of claim 18, wherein
the first light guide is a glass substrate which has a refractive index distribution for forming a plurality of optical waveguides, and
each of the transparent element and the second light guide is formed of a polymer in which refractive index anisotropy is nearly zero.

20. The display device of claim 18, wherein
each of the first light guide, the transparent element and the second light guide is formed of a polymer in which refractive index anisotropy is nearly zero.
